(19) United States
(12) Patent Application Publication
(10) Pub. No.: US 2017/0353974 A1
(43) Pub. Date: Dec. 7, 2017

(54) PAGING PERFORMANCE DURING INTER-FREQUENCY CELL RESELECTION SYSTEM INFORMATION BLOCK READS

(71) Applicant: QUALCOMM Incorporated, San Diego, CA (US)

(72) Inventors: Phaneendra Rupanagudi Venkata, San Diego, CA (US); Uzma Khan Qazi, San Marcos, CA (US)

(21) Appl. No.: 15/174,071

(22) Filed: Jun. 6, 2016

(51) Int. Cl. H04W 74/00; H04W 76/04; H04W 68/00

(52) U.S. Cl. CPC H04W 74/008; H04W 68/005; H04W 76/048

(57) ABSTRACT

A page reception method for the multi-subscriber identity module (SIM) mobile communication device includes: determining whether one or more upcoming system information block (SIB) system frame numbers (SFNs) will overlap with a PICH occasion on a paging indicator channel (PICH) for a subscription; in response to determining that the one or more upcoming SIB SFNs will overlap with the PICH occasion, identifying a repetition period of the one or more upcoming SIB SFNs; determining whether the repetition period of the one or more upcoming SIB SFNs is not less than a discontinuous reception receive (DRx) cycle for the PICH occasion; and in response to determining that the repetition period of the one or more upcoming SIB SFNs is not less than the discontinuous reception cycle for the PICH occasion, preventing decoding of the one or more upcoming SIB SFNs that overlap with the PICH occasion.

### BACKGROUND

During inter-frequency cell reselection for a subscription, system information block (SIB) reading occasions may overlap with paging occasions. For a single subscriber identity module (SIM) or multi-SIM, multi-standby (MSMS) mobile communication device, tuning to two different frequencies and reading the channels simultaneously is not possible since only a single radio frequency (RF) resource (e.g., an RF chain) may be available. Therefore, an interruption of incoming calls up to 1.5 seconds or more may result. Even if more than one RF resource is available, paging indicator channel (PICH) occasions may be skipped during inter-frequency cell reselection SIB reading.

Depending on the location and mobility of the mobile communication device and the coverage area with respect to the cells, back-to-back inter-frequency cell reselections may occur frequently. For example, if the mobile communication device is continuously moving in a high-speed vehicle, depending on cell topology and the location of the mobile communication device with respect to cell boundaries inter-frequency cell reselections may be triggered often. As a result, the mobile communication device may not receive incoming calls (e.g., emergency calls) and/or short message service (SMS) messages while the mobile communication device is reading the SIBs for the new cell.

### SUMMARY

Apparatuses and methods for handling pages during inter-frequency cell reselection system information block reads are provided.

According to various aspects there is provided a page reception method for the multi-subscriber identity module (SIM) mobile communication device having one radio frequency (RF) chain. In some aspects, the method may include: determining whether one or more upcoming system information block (SIB) system frame numbers (SFNs) will overlap with a paging indicator channel (PICH) occasion for a subscription; in response to determining that the one or more upcoming SIB SFNs will overlap with the PICH occasion, identifying a repetition period of the one or more upcoming SIB SFNs; determining whether the repetition period of the one or more upcoming SIB SFNs is not less than a discontinuous receive (DRx) cycle for the PICH occasion; and in response to determining that the repetition period of the one or more upcoming SIB SFNs is not less than the DRx cycle for the PICH occasion, preventing decoding of the one or more upcoming SIB SFNs that overlap with the PICH occasion.

According to various aspects there is provided a mobile communication device. In some aspects, the mobile communication device may include: a communication unit configured to communicate with one or more communication networks; a memory operably connected to the communication unit; a control unit operably connected to the communication unit and the memory.

The control unit may be configured to: determine whether one or more upcoming system information block (SIB) system frame numbers (SFNs) will overlap with a paging indicator channel (PICH) occasion for a subscription; in response to determining that the one or more upcoming SIB SFNs will overlap with the PICH occasion, identify a repetition period of the one or more upcoming SIB SFNs; determine whether the repetition period of the one or more upcoming SIB SFNs is not less than a discontinuous receive (DRx) cycle for the PICH occasion; and in response to determining that the repetition period of the one or more upcoming SIB SFNs is not less than the DRx cycle for the PICH occasion, prevent decoding of the one or more upcoming SIB SFNs that overlap with the PICH occasion.

According to various aspects there is provided a page reception method for the multi-subscriber identity module (SIM) mobile communication device having more than one radio frequency (RF) chain. In some aspects, the method may include: determining whether one or more upcoming system information block (SIB) system frame numbers (SFNs) for a first subscription (Sub1) on a first RF chain will overlap with a paging indicator channel (PICH) occasion for Sub1; in response to determining that the one or more upcoming SIB SFNs for Sub1 will overlap with the PICH occasion, determining if Sub1 can acquire control of a second RF chain; in response to determining that Sub1 can acquire control of the second RF chain, tuning to a frequency of the PICH for Sub1 on the second RF chain; and decoding the PICH for Sub1 using the second RF chain.

According to various aspects there is provided a mobile communication. In some aspects, the mobile communication may include: a plurality of communication units each configured to communicate with one or more communication networks, each communication unit including a radio frequency (RF) chain; a memory operably connected to the plurality of communication units; a control unit operably connected to the plurality of communication units and the memory.

The control unit configured to: determine whether one or more upcoming system information block (SIB) system frame numbers (SFNs) for a first subscription (Sub1) on a first RF chain of a first communication unit will overlap with a paging indicator channel (PICH) occasion for Sub1; in response to determining that the one or more upcoming SIB SFNs for Sub1 will overlap with the PICH occasion, determine if Sub1 can acquire control of a second RF chain of a second communication unit; in response to determining that Sub1 can acquire control of the second RF chain, control the second RF chain to tune to a frequency of the PICH for Sub1; and control the second communication unit to decode the PICH for Sub1 using the second RF chain.

Other features and advantages should be apparent from the following description, which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various examples;

FIG. 1B is a diagram illustrating a network environment for various examples;

FIG. 2 is a diagram illustrating page reception for a mobile communication device having an RF chain according to various examples;

FIG. 3 is a flowchart illustrating a page reception method for a multi-subscriber identity module (SIM) mobile communication device having one radio frequency (RF) chain according to various examples.

FIG. 4 is a diagram illustrating page reception for a mobile communication device having more than one RF chain according to various examples; and

FIG. 5 is a flowchart illustrating a page reception method for a multi-subscriber identity module (SIM) mobile communication device having more than one radio frequency (RF) chain according to various examples.

### DETAILED DESCRIPTION

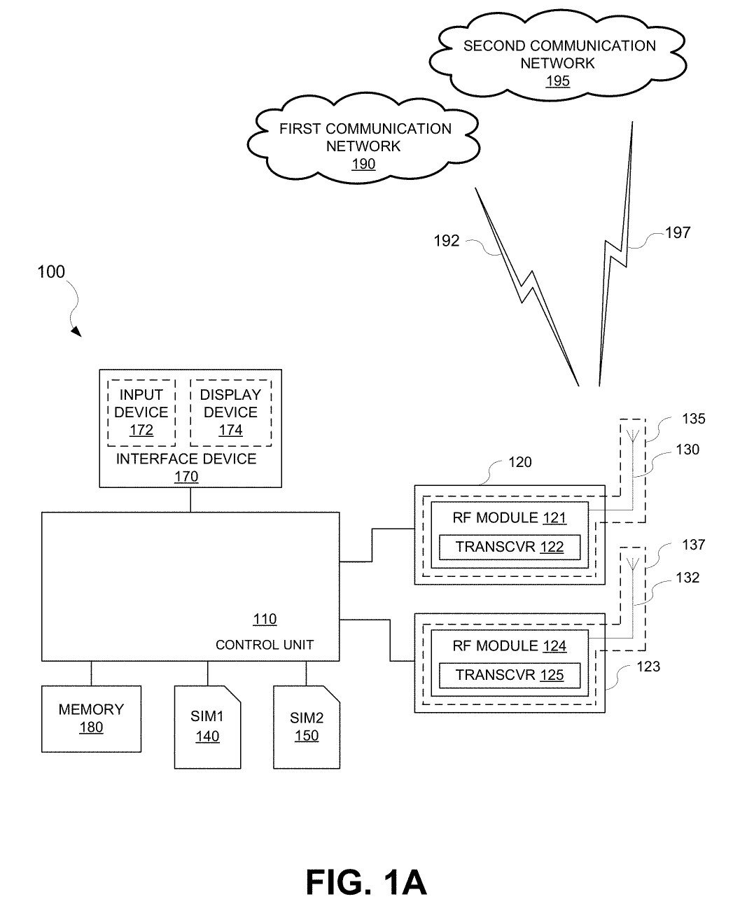

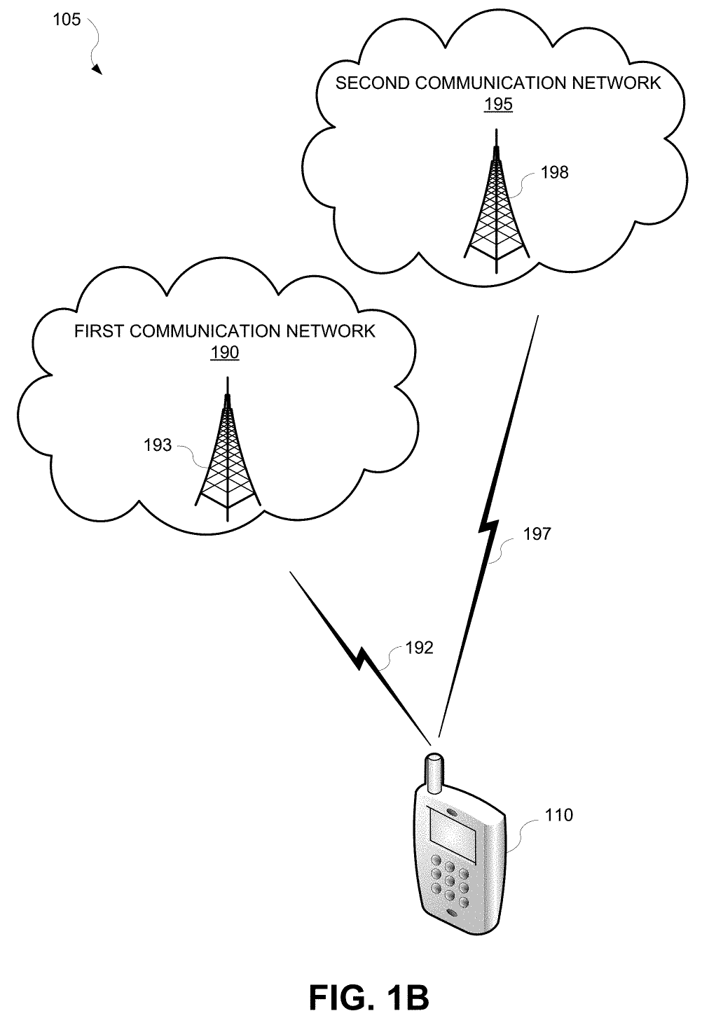

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection. FIG. 1A is a block diagram illustrating a mobile communication device 100 according to various embodiments. As illustrated in FIG. 1, the mobile communication device 100 may include a control unit 110, a first communication unit 120, a second communication unit 123, a first antenna 130, a second antenna 132, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The first communication unit 120 may include, for example, but not limited to, a first radio frequency (RF) module 121. The first RF module 121 may include, for example, but not limited to a first transceiver 122. A first RF chain 135 may include, for example, but not limited to the first antenna 130 and the first RF module 121.

The second communication unit 123 may include, for example, but not limited to, a second RF module 124. The second RF module 124 may include, for example, but not limited to a second transceiver 125. A second RF chain 137 may include, for example, but not limited to the second antenna 132 and the second RF module 124.

One of ordinary skill in the art will appreciate that embodiments of the mobile communication device 100 may include more than two communication units and/or more than two antennas without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the first communication unit 120 with a first subscription (Sub1) 192 associated with a first radio access technology (RAT) on a first communication network 190 and the second SIM 155 may associate the second communication unit 123 with a second subscription (Sub2) 197 associated with a second RAT on a second communication network 195.

For convenience, the various embodiments are described in terms of dual-SIM dual-standby (DSDS) mobile communication devices. However, one of ordinary skill in the art will appreciate that the various embodiments may be extended to multi-SIM multi-standby (MSMS) and/or multi-SIM multi-active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the first communication unit 120, the second communication unit 123, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, 1× evolution-data optimized (EV-DO), and time division-synchronous code division multiple access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

In idle mode, in addition to decoding pages a mobile communication device (e.g., the mobile communication device 100) constantly measures and evaluates neighboring cells and compares them with the serving cell. According to 3GPP TS 25.133, Section 4.2.2, a mobile communication device performs the following operations while in idle mode: measurement and evaluation of cell selection criteria of the serving cell; measurement of intra-frequency, inter-frequency frequency division duplex (FDD) neighbor cells, and inter-RAT neighbor cells; evaluation of neighbor cell re-selection criteria, ranking the neighbor cells, and triggering a cell reselection to the best neighbor cell; and reading SIBs of the selected neighbor cell and moving to the selected neighbor cell. Thus, based on reselection evaluation rules and thresholds, the mobile communication device 100 may trigger a reselection a neighbor cell having highest rank reselection criteria. The neighbor cell may be an inter-frequency cell operating on a different frequency than the current serving cell.

According to 3GPP TS 25.331, Section 8.1.1, system information elements are broadcast in the SIBs. A SIB groups together system information elements of the same nature. Different SIBs may have different characteristics, e.g., regarding the repetition period of the SIBs and the requirements on mobile communication device to re-read the SIBs.

A master information block (MIB) provides references and scheduling information regarding a number of SIBs in a cell. The MIB also provides a limited amount of system information such as downlink cell bandwidth. The SIBs contain most of the system information. The MIB may optionally also contain reference and scheduling information for one or two scheduling blocks which give references and scheduling information for additional SIBs. Different SIBs that are transmitted using the downlink shared channel (DL-SCH) contain the main part of system information. Similar to the MIB, the SIBs are broadcasted repeatedly.

Scheduling information for a SIB may only be included in either the MIB or one of the scheduling blocks. For all SIBs, except SIB types 15.2, 15.3 and 16, the content is the same in each occurrence for SIBs using a value tag. A MIB may contain a value tag for a SIB which the mobile communication device compares with the most recently read value tag for this SIB. The mobile communication device re-reads the SIB if its value tag has changed since the last reading of the SIB._SIB types 15.2, 15.3, and 16 may be broadcast more than once with different content. In this case, scheduling information is provided for each such occurrence of the SIB. SIBs that do not use a value tag may have different content for each broadcast.

Scheduling of SIBs is performed by the radio resource control (RRC) layer in the universal terrestrial radio access network (UTRAN). If SIB segmentation is used each SIB segment may be scheduled separately. To allow mixing of SIBs with short repetition periods and SIBs with segmentation over many frames (i.e., long repetition periods), the UTRAN may multiplex segments from different SIBs. Multiplexing and de-multiplexing is performed by the RRC layer.

The scheduling may be based on the cell system frame number (SFN). The SFN of a frame at which a particular segment i of a SIB occurs fulfills the following relation:
SFN mod SIB_REP=SIB_POS (i)
where i=0, 1, 2 . . . SEG_COUNT-1;
SEG_COUNT=number of segments in the SIB; and
SIB_REP=repetition period of the SIB.

According to 3GPP TS 25.133 (V13.1.0) Section 4.2.2.7, a mobile communication device performs the cell re-selection with minimum interruption in monitoring downlink channels for paging reception. For inter-frequency cell re-selection the interruption time should not exceed T_{SI}+50 ms, where T_{SI} is the time used for receiving all the relevant system information data according to the reception procedure, and the RRC procedure delay of SIBs defined in TS 25.331 for a UTRAN cell.

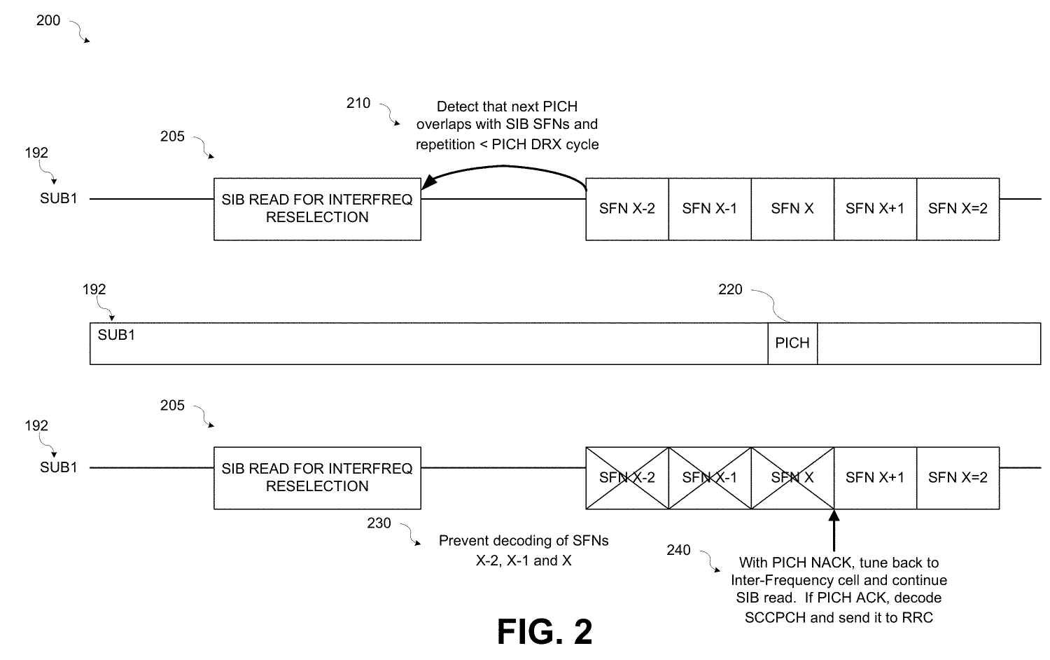

FIG. 2 is a diagram illustrating page reception 200 for a mobile communication device having an RF chain according to various examples. The mobile communication device may be a single SIM or multi-SIM mobile communication device having one RF chain. One of ordinary skill in the art will appreciate that the various examples are applicable to any RATs, for example, but not limited to, GSM/WCDMA/LTE/TD-SCDMA/CDMA/EV-DO, etc.

Referring to FIGS. 1A, 1B, and 2, during a SIB read for an inter-frequency cell reselection 205, at 210 it may be detected that a next PICH occasion 220 for a first subscription (e.g., Sub1 192) may overlap with upcoming SIB SFNs (e.g., SFNs X-2, X-1, X) within a threshold number of SFNs (e.g., 2-3 SFNs), and the repetition period for the overlapping SIBs may be less than the discontinuous receive (DRx) cycle for the PICH occasion 220. If the repetition period of any of the overlapping SIBs is less than the DRx cycle for the PICH occasion, then the SIBs may continue to be decoded without decoding the PICH occasion 220 since these SIBs will always overlap with PICH occasion 220 due to their repetition period with respect to PICH cycle and thus will continue colliding with the PICH occasion 220. Therefore, if these SIBs were prevented from being decoded in favor decoding the PICH occasion 220, these SIBs would never be decoded to complete the reselection procedure and mobile communication device 100 may remain camped on the current serving cell.

On the other hand, if during the SIB read for the inter-frequency cell reselection 205, it is detected that the repetition period for the overlapping SIBs (e.g., SFNs X-2, X-1, X) is not less than the DRx cycle for the PICH occasion 220, at block 230 decoding of the overlapping SIBs at SFNs X-2, X-1, X may be prevented (or skipped) and the mobile communication device 100 may tune back to the frequency of the current serving cell to decode the PICH occasion 220 and wait for the next repetition of the SIBs to decode the missing SIBs.

At block 240, when a PICH NACK (i.e., no page for Sub1 192) is decoded from the PICH occasion 220, the mobile communication device 100 may tune back to the inter-frequency cell and continue the SIB read. When a PICH ACK (i.e., a page for Sub1 192) is decoded from the PICH occasion 220, the mobile communication device 100 may decode the secondary common control physical channel (SCCPCH) and send the paging information to the RRC layer.

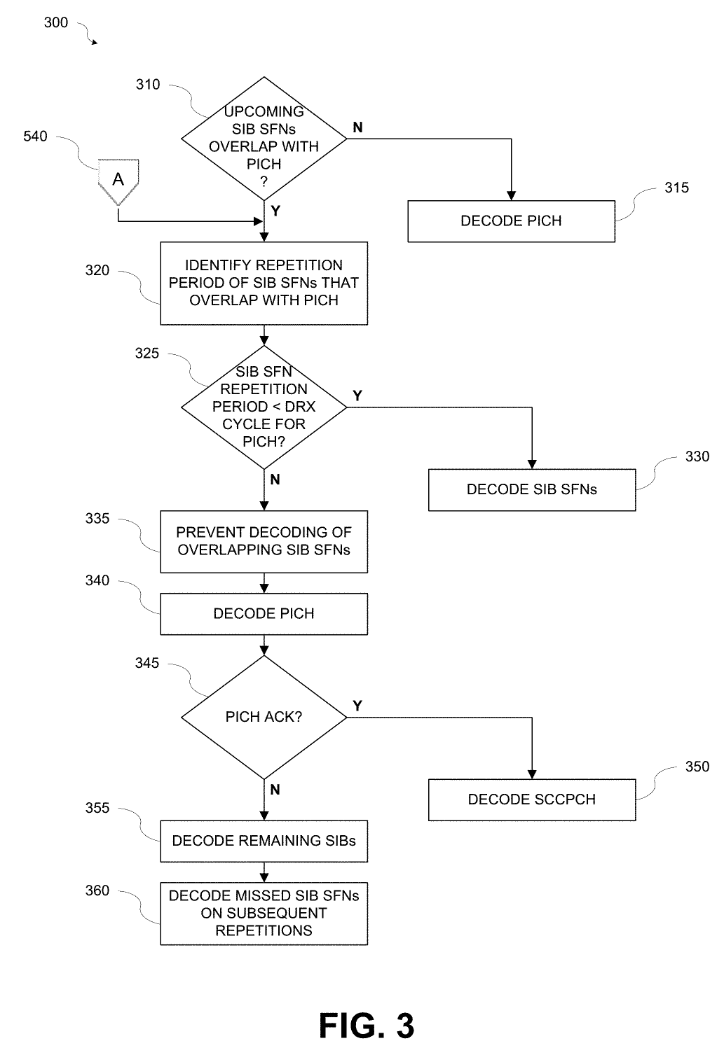

FIG. 3 is a flowchart illustrating a page reception method 300 for a multi-subscriber identity module (SIM) mobile communication device having one radio frequency (RF) chain according to various examples. Referring to FIGS. 1A-3, at block 310 the control unit 110 may determine whether upcoming SIB SFNs overlap with a PICH occasion 220. For example, the control unit 110 may determine whether upcoming SIB SFNs (e.g., SFNs X-2, X-1, X) within a threshold number of SFNs (e.g., 2-3 SFNs) overlap with the PICH occasion 220. In response to determining that upcoming SIB SFNs do not overlap with the PICH occasion 220 (310-N), at block 315 the control unit 110 may control the communication unit (e.g., the first communication unit 120) to decode the PICH occasion 220.

In response to determining that upcoming SIB SFNs overlap with the PICH occasion 220 (310-Y), at block 320 the control unit 110 may identify the repetition period of the SIBs that overlap with the PICH occasion 220. At block 325, the control unit 110 may determine whether the repetition period for the overlapping SIBs is less than the DRx cycle for the PICH occasion 220. In response to determining that the repetition period for the overlapping SIBs is less than the DRx cycle for the PICH occasion 220 (325-Y), at block 330 the control unit 110 may control the first communication unit 120 to decode the SIBs that overlap with the PICH occasion 220.

If the repetition period for the overlapping SIBs is less than the DRx cycle for the PICH occasion the overlapping SIBs will always collide with PICH due to the relationship of the repetition period of the overlapping SIBs with respect to the PICH cycle. The SIBs may continue to not be decoded resulting in a failure to complete the reselection procedure. As a result, the mobile communication device 100 may stay camped on a less than optimum serving cell. The PICH occasion 220 for the current serving cell may not be decoded because the new serving cell may not be decoded until after cell reselection is completed.

In response to determining that the repetition period for the overlapping SIBs is not less than the DRx cycle for the PICH occasion 220 (325-N), at block 335 the control unit 110 may control the first communication unit 120 to prevent decoding the SIBs that overlap with the PICH occasion 220. For example, the control unit 110 may control the first communication unit 120 to prevent SIB SFNs X-2, X-1, and X from being decoded. In RRC Idle mode, the DRx cycle may be used to determine how frequently the mobile communication device 100 checks for paging messages where the mobile communication device 100 checks for paging messages once every DRx cycle.

At block 340, the control unit 110 may control the first communication unit 120 to decode the PICH occasion 220. At block 345, the control unit may determine whether a PICH acknowledgment (ACK) is received. For example, the control unit 110 may determine that the PICH occasion 220 is successfully decoded and may determine that there is a page for Sub1 192 (i.e., a PICH ACK is received). In response to determining that a PICH ACK is received (345-Y), at block 350 the control unit 110 may control the first communication unit 120 to decode the SCCPCH and determine the paging message. The SCCPCH carries the Paging Channel (PCH) and Forward Access Channel (FACH) transport channels. For each defined PCH there is an associated PICH. The decoded SCCPCH information may be passed to the RRC layer. When there is a PCH or FACH information to transmit, the SCCPCH is transmitted. The SCCPCH is decoded by the mobile communication device 100 when it expects a useful message on the PCH or FACH.

In response to determining that a PICH ACK is not received (345-N), at block 355 the control unit 110 may control the first communication unit 120 to decode the remaining SIBs. At block 360, the control unit 110 may control the first communication unit 120 to decode on subsequent broadcast repetitions the overlapping SIBs that were previously not decoded. Accordingly, the mobile communication device 100 may perform multiple inter-frequency reselections in high mobility situations while minimizing missed pages and/or calls.

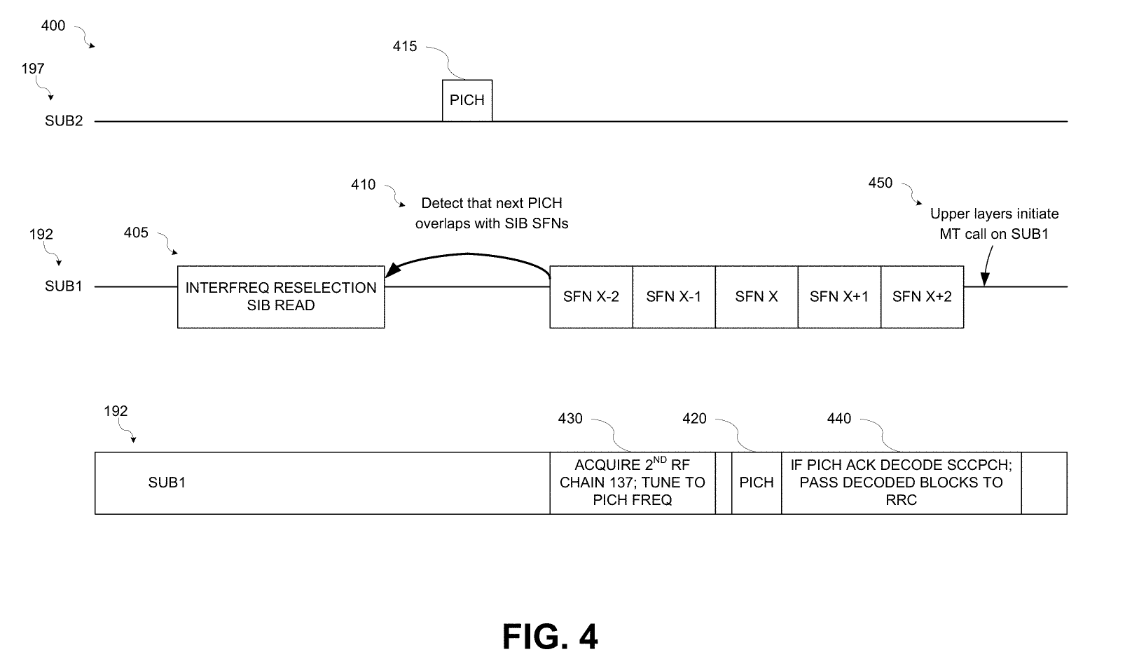

FIG. 4 is a diagram illustrating page reception 400 for a mobile communication device having more than one RF chain according to various examples. Referring to FIGS. 1A, 1B, and 4, during a SIB read for an inter-frequency cell reselection 405, at 410 it may be detected that a next PICH occasion 420 for a first subscription (e.g., Sub1 192) may overlap with SIB SFNs (e.g., SFNs X-2, X-1, X). Sub2 197 may be in idle mode and may wake up to decode a PICH occasion 415 using a second RF chain (e.g., the second RF chain 137). After decoding the PICH occasion 415 Sub2 197 may return to idle mode. At block 430, Sub1 192 may acquire a second RF chain (e.g., the second RF chain 137) and tune to the PICH frequency before the paging block arrives using the second RF chain 137.

At block 440, when a PICH ACK (i.e., a page for Sub1 192) is decoded from the PICH occasion 420, the mobile communication device 100 may decode the secondary common control physical channel (SCCPCH) using the second RF chain 137 and send the paging information to the RRC layer. At block 450, the upper layers of the protocol stack may be responsible for establishing incoming mobile terminated (MT) calls. Thus, both the paging performance and SIB reading/reselection performance may be improved. One of ordinary skill in the art will appreciate that the various examples are applicable to any RATs, for example, but not limited to, GSM/WCDMA/LTE/TD-SCDMA/CDMA/EV-DO, etc.

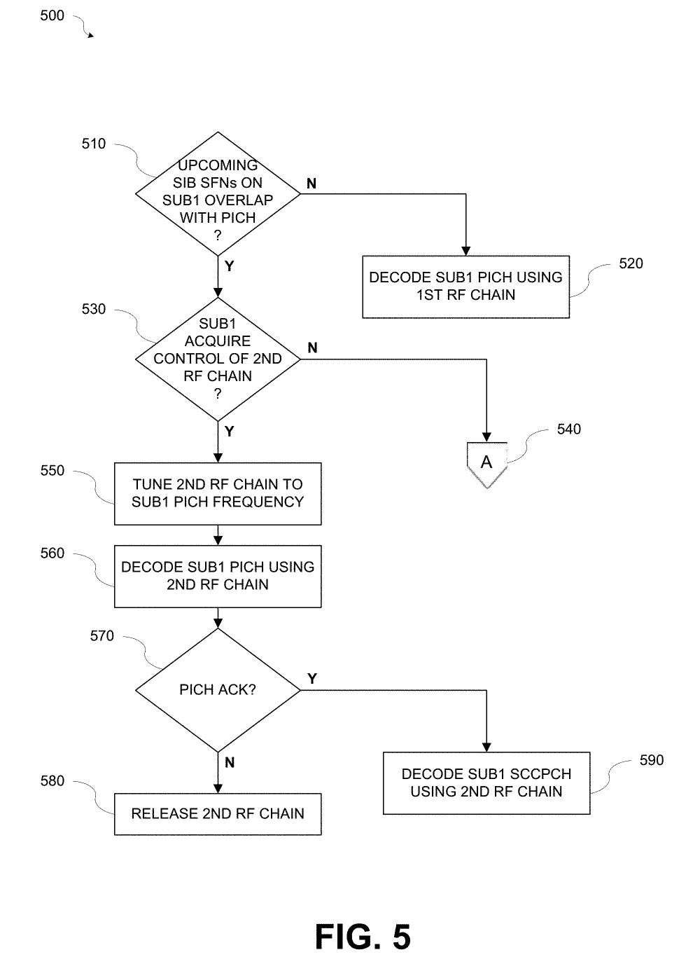

FIG. 5 is a flowchart illustrating a page reception method 500 for a multi-subscriber identity module (SIM) mobile communication device having more than one radio frequency (RF) chain according to various examples. Referring to FIGS. 1A-4, at block 510 the control unit 110 may determine whether upcoming SIB SFNs on a first subscription (e.g., Sub1 192) overlap with a PICH occasion 420. For example, the control unit 110 may determine whether upcoming SIB SFNs (e.g., SFNs X-2, X-1, X) within a threshold number of SFNs (e.g., 2-3 SFNs) overlap with the PICH occasion 420. In response to determining that upcoming SIB SFNs do not overlap with the PICH occasion 420 (510-N), at block 520 the control unit 110 may control the communication unit (e.g., the first communication unit 120) to decode the PICH occasion 420 on Sub1 192 using the a first RF chain (e.g., the first RF chain 135).

In response to determining that upcoming SIB SFNs overlap with the PICH occasion 220 (510-Y), at block 530 the control unit 110 may determine if Sub1 192 can acquire control of a second RF chain (e.g., the second RF chain 137). In response to determining that Sub1 192 cannot acquire control of the second RF chain 137 (530-N), at block 540 the control unit 110 may cause operation of the mobile communication device 100 to fall back to the method 300 beginning at block 320. For example, Sub1 192 may be unable to acquire control of the second RF chain 137 when another subscription (e.g., Sub2 197) is using the second RF chain 137 for a higher priority activity (e.g., a voice call) than the cell reselection on Sub1 192.

In response to determining that Sub1 192 can acquire control of the second RF chain 137 (530-Y), at block 550 the control unit 110 may control the second RF chain 137 to tune to the frequency of the Sub1 192 PICH occasion 420. At block 560, the control unit 110 may control the second communication unit 123 to decode the Sub1 PICH occasion 420 using the second RF chain 137.

At block 570, the control unit may determine whether a PICH ACK is received. For example, the control unit 110 may determine that the PICH occasion 420 is successfully decoded and may determine that there is a page for Sub1 192 (i.e., a PICH ACK is received). In response to determining that a PICH ACK is received (570-Y), at block 350 the control unit 110 may control the second communication unit 123 to decode the SCCPCH using the second RF chain 137. The decoded SCCPCH information may be passed to the RRC. In response to determining that a PICH ACK is not received (570-N), at block 580 the control unit 110 may cause Sub1 192 to release the second RF chain 137.

The methods 300 and 500, respectively, may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments should be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A page reception method for a multi-subscriber identity module (SIM) mobile communication device having one radio frequency (RF) chain, the method comprising:
determining whether one or more upcoming system information block (SIB) system frame numbers (SFNs) will overlap with a paging indicator channel (PICH) occasion for a subscription;
in response to determining that the one or more upcoming SIB SFNs will overlap with the PICH occasion, identifying a repetition period of the one or more upcoming SIB SFNs;
determining whether the repetition period of the one or more upcoming SIB SFNs is not less than a discontinuous receive (DRx) cycle for the PICH occasion; and
in response to determining that the repetition period of the one or more upcoming SIB SFNs is not less than the DRx cycle for the PICH occasion, preventing decoding of the one or more upcoming SIB SFNs that overlap with the PICH occasion.

2. The method of claim 1, further comprising:
decoding the PICH occasion; and
determining whether the PICH occasion indicates a page for the subscription.

3. The method of claim 2, further comprising:
in response to determining that the PICH occasion does not indicate a page for the subscription, decoding SIB SFNs received after decoding the PICH occasion.

4. The method of claim 3, further comprising:
decoding on subsequent broadcast repetitions one or more SIB SFNs that were previously prevented from being decoded,
where in the SIB SFNs are broadcast on one of global system for mobile communications (GSM), wideband code division multiple access (WCDMA), long term evolution (LTE), time division-synchronous code division multiple access (TD-SCDMA), code division multiple access (CDMA), and evolution-data optimized (EV-DO) radio access technologies.

5. The method of claim 1, further comprising:
in response to determining that the repetition period of the one or more upcoming SIB SFNs is less than the DRx cycle for the PICH occasion, decoding the one or more upcoming SIB SFNs.

6. The method of claim 1, further comprising:
in response to determining that the one or more upcoming SIB SFNs will not overlap with the PICH occasion, decoding the PICH occasion.

7. A mobile communication device, comprising:
a communication unit configured to communicate with one or more communication networks;
a memory operably connected to the communication unit;
a control unit operably connected to the communication unit and the memory, the control unit configured to:
determine whether one or more upcoming system information block (SIB) system frame numbers (SFNs) will overlap with a paging indicator channel (PICH) occasion for a subscription;
in response to determining that the one or more upcoming SIB SFNs will overlap with the PICH occasion, identify a repetition period of the one or more upcoming SIB SFNs;
determine whether the repetition period of the one or more upcoming SIB SFNs is not less than a discontinuous reception receive (DRx) cycle for the PICH occasion; and
in response to determining that the repetition period of the one or more upcoming SIB SFNs is not less than the DRx cycle for the PICH occasion, prevent decoding of the one or more upcoming SIB SFNs that overlap with the PICH occasion.

8. The mobile communication device of claim 7, wherein the control unit is configured to decode the PICH occasion; and
determine whether the PICH occasion indicates a page for the subscription.

9. The mobile communication device of claim 8, wherein:
in response to determining that the PICH occasion does not indicate a page for the subscription, the control unit is configured to decode SIB SFNs received after decoding the PICH occasion,
where in the SIB SFNs are broadcast on one of global system for mobile communications (GSM), wideband code division multiple access (WCDMA), long term evolution (LTE), time division-synchronous code division multiple access (TD-SCDMA), code division multiple access (CDMA), and evolution-data optimized (EV-DO) radio access technologies.

10. The mobile communication device of claim 9, wherein the control unit is configured to decode on subsequent broadcast repetitions one or more SIB SFNs that were previously prevented from being decoded.

11. The mobile communication device of claim 7, wherein:
in response to determining that the repetition period of the one or more upcoming SIB SFNs is less than the DRx cycle for the PICH occasion, the control unit is configured to decode the one or more upcoming SIB SFNs.

12. The mobile communication device of claim 7, wherein:
in response to determining that the one or more upcoming SIB SFNs will not overlap with the PICH occasion, the control unit is configured to decode the PICH occasion.

13. A page reception method for a multi-subscriber identity module (SIM) mobile communication device having more than one radio frequency (RF) chain, the method comprising:
determining whether one or more upcoming system information block (SIB) system frame numbers (SFNs) for a first subscription (Sub1) on a first RF chain will overlap with a paging indicator channel (PICH) occasion for Sub1;
in response to determining that the one or more upcoming SIB SFNs for Sub1 will overlap with the PICH occasion, determining if Sub1 can acquire control of a second RF chain;
in response to determining that Sub1 can acquire control of the second RF chain, tuning to a frequency of the PICH occasion for Sub1 on the second RF chain; and
decoding the PICH occasion for Sub1 using the second RF chain.

14. The method of claim 13, further comprising:
determining whether the PICH occasion indicates a page for Sub1; and
in response to determining that the PICH occasion indicates a page for Sub1, decoding a secondary common control physical channel (SCCPCH) for Sub1 using the second RF chain.

15. The method of claim 14, further comprising:
in response to determining that the PICH occasion does not indicate a page for Sub1, releasing control of the second RF chain by Sub1.

16. The method of claim 13, further comprising:
in response to determining that Sub1 cannot acquire control of the second RF chain, identifying a repetition period of the one or more upcoming SIB SFNs for Sub1;
determining whether the repetition period of the one or more upcoming SIB SFNs is not less than a discontinuous receive (DRx) cycle for the PICH occasion for Sub1; and
in response to determining that the repetition period of the one or more upcoming SIB SFNs is not less than the DRx cycle for the PICH occasion, preventing decoding of the one or more upcoming SIB SFNs that overlap with the PICH occasion.

17. The method of claim 16, further comprising:
decoding the PICH occasion; and
determining whether the PICH occasion indicates a page for Sub1.

18. The method of claim 17, further comprising:
in response to determining that the PICH occasion does not indicate a page for Sub1, decoding SIB SFNs received after decoding the PICH occasion.

19. The method of claim 18, further comprising:
decoding on subsequent broadcast repetitions one or more SIB SFNs that were prevented from being decoded.

20. The method of claim 16, further comprising:
in response to determining that the repetition period of the one or more upcoming SIB SFNs is less than the DRx cycle for the PICH occasion, decoding the one or more upcoming SIB SFNs.

21. The method of claim 16, further comprising:
in response to determining that the one or more upcoming SIB SFNs will not overlap with the PICH occasion, decoding the PICH occasion.

22. A mobile communication device, comprising:
a plurality of communication units each configured to communicate with one or more communication networks, each communication unit including a radio frequency (RF) chain;
a memory operably connected to the plurality of communication units;
a control unit operably connected to the plurality of communication units and the memory, the control unit configured to:
determine whether one or more upcoming system information block (SIB) system frame numbers (SFNs) for a first subscription (Sub1) on a first RF chain of a first communication unit will overlap with a paging indicator channel (PICH) occasion for Sub1;
in response to determining that the one or more upcoming SIB SFNs for Sub1 will overlap with the PICH occasion, determine if Sub1 can acquire control of a second RF chain of a second communication unit;
in response to determining that Sub1 can acquire control of the second RF chain, control the second RF chain to tune to a frequency of the PICH occasion for Sub1; and
control the second communication unit to decode the PICH occasion for Sub1 using the second RF chain.

23. The mobile communication device of claim 22, wherein the control unit is configured to determine whether the PICH occasion indicates a page for Sub1; and
in response to determining that the PICH occasion indicates a page for Sub1, the control unit is configured to control the second communication unit to decode a secondary common control physical channel (SCCPCH) for Sub1 using the second RF chain.

24. The mobile communication device of claim 23, wherein:
in response to determining that the PICH occasion does not indicate a page for Sub1, the control unit controls the second communication unit to release control of the second RF chain by Sub1.

25. The mobile communication device of claim 22, wherein:
in response to determining that Sub1 cannot acquire control of the second RF chain, the control unit is configured to identify a repetition period of the one or more upcoming SIB SFNs for Sub1;
determine whether the repetition period of the one or more upcoming SIB SFNs is not less than a discontinuous receive (DRx) cycle for the PICH occasion for Sub1; and
in response to determining that the repetition period of the one or more upcoming SIB SFNs is not less than the DRx cycle for the PICH occasion, prevent decoding of the one or more upcoming SIB SFNs that overlap with the PICH occasion.

26. The mobile communication device of claim 25, wherein the control unit is configured to:
decode the PICH occasion; and
determine whether the PICH occasion indicates a page for Sub1.

27. The mobile communication device of claim 26, further wherein:
in response to determining that the PICH occasion does not indicate a page for Sub1, the control unit is configured to decode SIB SFNs received after decoding the PICH occasion.

28. The mobile communication device of claim 27, wherein the control unit is configured to:
decode on subsequent broadcast repetitions one or more SIB SFNs that were prevented from being decoded.

29. The mobile communication device of claim 25, wherein:
in response to determining that the repetition period of the one or more upcoming SIB SFNs is less than the DRx cycle for the PICH occasion, the control unit is configured to decode the one or more upcoming SIB SFNs.

30. The mobile communication device of claim 25, wherein:
in response to determining that the one or more upcoming SIB SFNs will not overlap with the PICH occasion, the control unit is configured to decode the PICH occasion.
